(19) United States
(12) Patent Application Publication
(10) Pub. No.: US 2008/0109215 A1
(43) Pub. Date: May 8, 2008

(54) High frequency reconstruction by linear extrapolation

(76) Inventors: Chi-min Liu, Hsinchu City (TW); Wen-chieh Lee, Taoyuan City (TW); Han-Wen Hsu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/474,277

(22) Filed: Jun. 26, 2006

(51) Int. Cl. G10L 19/00

(52) U.S. Cl. 704/200.1

(57) ABSTRACT

High frequency components of audio signals are reconstructed from the aspects of envelope and fine detail. The envelopes of the high frequency components are found through linear extrapolation of signals with frequencies lower than a cutoff frequency point. One method of reconstructing high frequency components is based on the linear extrapolation on the logarithm scale magnitudes of the transform coefficients of the audio signal in a frequency domain. The linear extrapolation is a linear approximation based on minimizing least squares of the logarithm scale magnitudes of the transform coefficients of the low frequency components. Another method is based on the linear extrapolation on the logarithm scale magnitudes of the envelope elements of the filterbank signals of the audio signal over a time segment. The linear extrapolation is a linear approximation based on minimizing least squares of the logarithm scale magnitudes of the envelope elements of the low frequency filterbank signals.

### FIELD OF THE INVENTION

The present invention generally relates to the reconstruction of audio signals, and more specifically to the reconstruction of high frequency components in the audio signals.

### BACKGROUND OF THE INVENTION

In the reconstruction of audio signals, the high frequency components are usually lost due to two main reasons. One is the band limitation before sampling the audio signals and the other is the allocation of more bits to the lower frequency components. To avoid aliasing effects, a wideband signal should be band-limited to a narrowband signal to meet the Nyquist rate criterion before sampling. Because of limited bit rate for compression, most audio compression CODEC's scarify the bits required for high frequency and put all available bits to the low frequency components that are more relevant for human hearing. As shown in FIG. 1, it is desirable to reconstruct the high frequency components lost.

Some attempts have been made to extrapolate a wideband signal from its narrowband frequency components. However, most of them are limited to the reconstruction of speech instead of a general audio signal. An advanced scheme referred to as “spectral band replication (SBR)” has become the reference model of the MPEG-4 version 3 audio standard to compress high frequency contents. The SBR scheme requires side information on the frequency contents extracted in an encoder to assist the reconstruction of the high frequency contents in a decoder.

Various systems for extending an audio bandwidth in the decoder for improving the sound quality of audio signals have been proposed. Among them, autocorrelation coefficients and linear predictive coding residuals of a time region from an input audio signal have been used to synthesize output audio signals and extend the bandwidth.

There has been a strong need in developing an effective method for reconstructing the lost high frequency components in audio signals to provide better sound quality.

### SUMMARY OF THE INVENTION

The present invention has been made to meet the need of a high frequency reconstruction system and method which does not need additional information from either encoders or decoders. All the encoded music with limited bandwidth can be reconstructed to improve the perceptual quality. In the method of this invention audio signals are reconstructed from the aspects of envelope and fine detail. The envelopes of the high frequency components are found through linear extrapolation of signals with frequencies lower than a cutoff frequency point. The envelope is estimated by a linear model in a logarithm scale using a least-square method.

An object of the invention is to provide a method of reconstructing high frequency components of an audio signal based on the linear extrapolation on the logarithm scale magnitudes of the transform coefficients of the audio signal in a frequency domain. The linear extrapolation is a linear approximation based on minimizing least squares of the logarithm scale magnitudes of the transform coefficients of the low frequency components.

Accordingly, the high frequency audio signal reconstruction system of the present invention comprises a transform module for transforming an audio signal into transform coefficients in the frequency domain, a high frequency reconstruction module for reconstructing transform coefficients of high frequency components by means of linear extrapolation based on minimizing least squares of the logarithm scale magnitudes of the transform coefficients of lower frequency components, and an inverse transform module for transforming the transform coefficients of the lower frequency components and the reconstructed high frequency components to synthesize the output audio signal.

Another object of the invention is to provide a method of reconstructing high frequency components of an audio signal based on the linear extrapolation on the logarithm scale magnitudes of the envelope elements of the filterbank signals of the audio signal over a time segment. The linear extrapolation is a linear approximation based on minimizing least squares of the logarithm scale magnitudes of the envelope elements of the low frequency filterbank signals.

Accordingly, the high frequency audio signal reconstruction system of the present invention comprises an analysis filterbank for splitting an audio signal over a time segment into a plurality of filterbank signals, a high frequency reconstruction module for reconstructing high frequency filterbank signals by means of linear extrapolation based on minimizing least squares of the logarithm scale magnitudes of the envelope elements of lower frequency filterbank signals, and a synthesis filterbank module for combining the lower frequency filterbank signals and the reconstructed high frequency filterbank signals to synthesize the output audio signal.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 illustrates the reconstruction of the high frequency components lost in an audio signal.

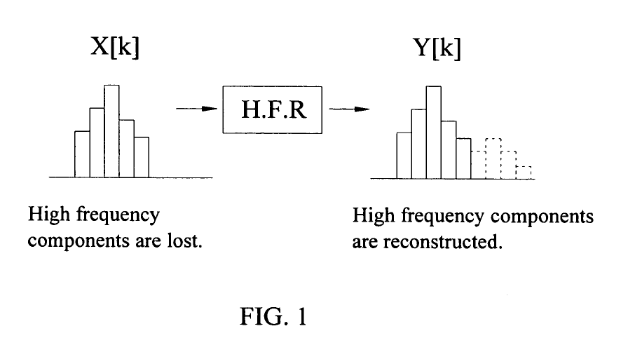

FIG. 2 shows a block diagram of the high frequency reconstruction system based on the transform coefficients of an audio signal in a frequency domain according to the first embodiment of this invention.

FIG. 3 illustrates linear extrapolation on the logarithm scale magnitudes of the transform coefficients.

FIG. 4 shows the signal flow diagram of the fast computing method according to this invention.

FIG. 5 shows the spectrum of an original audio signal.

FIG. 6 shows the spectrum of the audio signal of FIG. 5 with bandwidth extension.

FIG. 7 shows the block diagram of the frequency domain based high frequency construction method according to this invention.

FIG. 8 shows the flow chart of the frequency domain method for reconstructing high frequency components of audio signals.

FIG. 9 shows a block diagram of the high frequency reconstruction system based on filterbank signals of an audio signal over a time segment according to the second embodiment of this invention.

FIG. 10 shows the block diagram of the filterbank signal based high frequency construction method according to this invention.

FIG. 11 shows the flow chart of the filterbank signal method for reconstructing high frequency components of audio signals.

FIG. 12 shows the block diagram of an MP3 encoder in which the frequency domain method of high frequency reconstruction of this invention is incorporated.

FIG. 13 shows a block diagram of an MPEG layer III encoder.

FIG. 14 shows the block diagram of an MP3 encoder in which the filterbank signal method of high frequency reconstruction of this invention is incorporated.

### DETAILED DESCRIPTION OF THE PREFERRED EMBODIMENTS

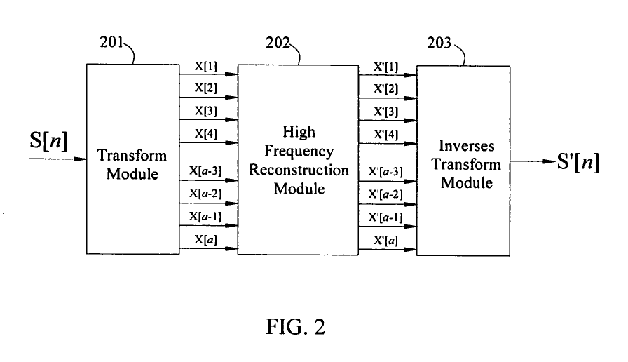

In the first embodiment of the present invention, a frequency-domain method is provided for reconstructing the high frequency components of an audio signal. The reconstruction method is based on the transform coefficients of the audio signal. FIG. 2 illustrates the block diagram of the high frequency reconstruction system using the frequency-domain method.

The high frequency audio signal reconstruction system as shown in FIG. 2 comprises a transform module 201 for transforming an audio signal into transform coefficients in the frequency domain. A high frequency reconstruction module 202 reconstructs transform coefficients of high frequency components by means of linear extrapolation based on minimizing least squares of the logarithm scale magnitudes of the transform coefficients of lower frequency components. An inverse transform module 203 transforms the transform coefficients of the lower frequency components and the reconstructed high frequency components to synthesize the output audio signal.

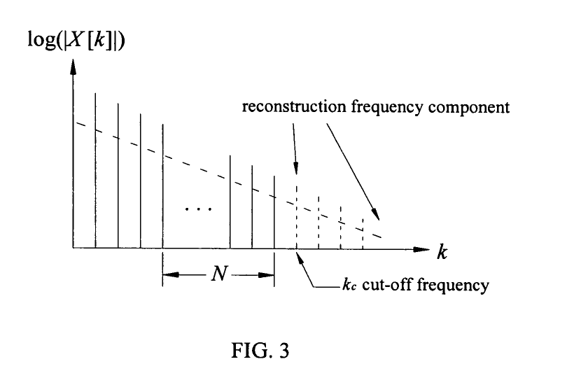

Let X[k] be the spectrum signals at some time frame. The method reconstructs the high frequency signals with linear extrapolation on the magnitude in the logarithm scale. The logarithm scale in magnitude is adopted based on the magnitude absorption model. The frequency scale is in linear model because of the harmonic extension in linear scale. According to the assumption, the signals are reconstructed from the aspects of envelope and fine detail. The envelope of the high frequency is found through the linear extrapolation of signals with frequencies lower than the reconstructed point, say k_{c}. On the detailed spectrum, the unit spectrum from the low frequency signals is found and then used to reproduce the high frequency to fit the envelope defined. FIG. 3 illustrates the concept.

According to this invention, the envelope is estimated by a linear model using a least-squares method. The following derivation is presented to explain the method of this invention. Given a set M consists of N frequency lines with logarithm magnitude, i.e.,

M={ln(|X[k_{c}−N]), ln(|X[k_{c}−(N−1)]), . . . , ln(|X[k_{c}−1])}. (1)

Assume ln|X[k]|=aₐₚₜ·k+bₒₚₜ is the linear approximation with the least-square method on the N frequency lines. The first order parameter aₒₚₜ, and zero order parameter bₒₚₜ can be found as:

$$\begin{matrix}\begin{matrix}{a}_{opt} = \frac{12}{( N - 1 ) N ( N + 1 )} \cdot \\ ln \{ {\prod }_{i = 1}^{\frac{N - 1}{2}} {[ \frac{\vert X [ {k}_{c} - i ] \vert}{\vert X [ {k}_{c} - ( N + 1 - i ) ] \vert} ]}^{( \frac{N + 1}{2} - i )} \} ,\end{matrix} & ( 2 ) \\ and & \\ {b}_{opt} = \frac{ln ( {\prod }_{i = 1}^{N} \vert X [ {k}_{c} - i ] \vert )}{N} - ( {k}_{c} - \frac{N + 1}{2} ) {a}_{opt} . & ( 3 )\end{matrix}$$

To determine aₒₚₜ and bₒₚₜ, it is known that the least squares are such that the summation

$$\begin{matrix}{\sum }_{i = 1}^{N} {[ b + ( {k}_{c} - i ) a - ln \vert ( X [ {k}_{c} - i ] ) \vert ]}^{2} = {\sum }_{i = 1}^{N} {[ \begin{matrix}b + ( {k}_{c} - i ) a - \\ {X}^{′} [ {k}_{c} - i ]\end{matrix} ]}^{2} \\ = {‖ \begin{matrix}[ \begin{matrix}1 & {k}_{c} - 1 \\ 1 & {k}_{c} - 2 \\ ⋮ & ⋮ \\ 1 & {k}_{c} - N\end{matrix} ] [ \begin{matrix}b \\ a\end{matrix} ] - \\ [ \begin{matrix}{X}^{′} [ {k}_{c} - 1 ] \\ {X}^{′} [ {k}_{c} - 2 ] \\ ⋮ \\ {X}^{′} [ {k}_{c} - N ]\end{matrix} ]\end{matrix} ‖}^{2}\end{matrix} \qquad ( 4 )$$

has the minimum value, where X′[k_{c}−i]=ln(|X[k_{c}−i]). The equation can be solved by solving a normal equation, i.e.,

$$[ \begin{matrix}1 & 1 , & … , & 1 \\ {k}_{c} - 1 & {k}_{c} - 2 , & … , & {k}_{c} - N\end{matrix} ] [ \begin{matrix}1 & {k}_{c} - 1 \\ 1 & {k}_{c} - 2 \\ ⋮ & ⋮ \\ 1 {k}_{c} & - N\end{matrix} ] [ \begin{matrix}k \\ a\end{matrix} ] = \\ [ \begin{matrix}1 & 1 , & … , & 1 \\ {k}_{c} - 1 & {k}_{c} - 2 , & … , & {k}_{c} - N\end{matrix} ] [ \begin{matrix}{X}^{′ } \\ {X}^{′ } \\ \\ {X}^{′ }\end{matrix} \\ \text{indicates text missing or illegible when filed} \qquad ( 5 )$$

### This is equivalent to solving the equation (6).

$$[ \begin{matrix}N & {Nk}_{c} - \frac{N ( N + 1 )}{2} \\ {Nk}_{c} - \frac{N ( N + 1 )}{2} & {Nk}_{c}^{2} - N ( N + 1 ) {k}_{c} + \frac{N ( N + 1 ) ( 2 N + 1 )}{6}\end{matrix} ] [ \begin{matrix}b \\ a\end{matrix} ] = [ \begin{matrix}{\sum }_{i = 1}^{N} {X}^{′} [ {k}_{c} - i ] \\ {k}_{c} \cdot {\sum }_{i = 1}^{N} {X}^{′} [ {k}_{c} - i ] - {\sum }_{i = 1}^{N} i \cdot {X}^{′} [ {k}_{c} - i ]\end{matrix} ] \qquad ( 6 )$$

### By Gaussian-Jordan elimination method, (6) can be reduced to

$$[ \begin{matrix}1 & {k}_{c} - \frac{N + 1}{2} \\ 0 & \frac{( N - 1 ) N ( N + 1 )}{12}\end{matrix} ] [ \begin{matrix}b \\ a\end{matrix} ] = [ \begin{matrix}\frac{{\sum }_{i = 1}^{N} {X}^{′} [ {k}_{c} - i ]}{N} \\ {\sum }_{i = 1}^{N} ( \frac{N + 1}{2} - i ) {X}^{′} [ {k}_{c} - i ]\end{matrix} ] \qquad ( 7 )$$

The optimum solution aₒₚₜ and bₒₚₜ can be found by solving (7). The complexity of calculating aₒₚₜ is O(N²), where N is the number of frequency lines in predicting the envelope. In the following, a fast computing method is presented.

Assume N is positive integer and N>1. Yᵢ and Wᵢ are used to denote terms in (2) according to

$$\begin{matrix}{Y}_{i} = X [ {k}_{c} - i ] ; for i = 1 , 2 , … , \frac{N - 1}{2} , & ( 8 ) \\ and & \\ {W}_{i} = X [ {k}_{c} - ( N + 1 - i ) ] ; for i = 1 , 2 , … , \frac{N - 1}{2} & ( 9 )\end{matrix}$$

### Substituting (8) and (9) into (2) yields

$$\begin{matrix}{a}_{opt} = \frac{12}{( N - 1 ) N ( N + 1 )} \cdot \{ \begin{matrix}ln [ {\prod }_{i = 1}^{\frac{N - 1}{2}} {\vert {Y}_{i} \vert}^{( \frac{N + 1}{2} - i )} ] - \\ ln [ {\prod }_{i = 1}^{\frac{N - 1}{2}} {\vert {W}_{i} \vert}^{( \frac{N + 1}{2} - i )} ]\end{matrix} \} . & ( 10 ) \\ That is & \\ {a}_{opt} = \frac{12}{( N - 1 ) N ( N + 1 )} \cdot \{ \begin{matrix}ln [ \vert {\prod }_{i = 1}^{\frac{N - 1}{2}} {{Y}_{i}}^{( \frac{N + 1}{2} - i )} \vert ] - \\ ln [ \vert {\prod }_{i = 1}^{\frac{N - 1}{2}} {{W}_{i}}^{( \frac{N + 1}{2} - i )} \vert ]\end{matrix} \} . & ( 11 )\end{matrix}$$

### Furthermore, the product of a series of Yⱼ is defined as Zᵢ, i.e.,

$${Z}_{i} = {\prod }_{j = 1}^{i} {Y}_{j} ; for i = 1 , 2 , … , \frac{N - 1}{2} . \qquad ( 12 )$$

### Taking a recursive way to calculate Zᵢ leads to

$${Z}_{i} = {Z}_{i - 1} \cdot {Y}_{i} ; for i = 1 , 2 , … , \frac{N - 1}{2} , \qquad ( 13 )$$

with Z₀=1. Similarly, the product of a series of Wⱼ can be defined as Vᵢ, i.e.,

$${V}_{i} = {\prod }_{j = 1}^{i} {W}_{j} ; for i = 1 , 2 , … , \frac{N - 1}{2} . \qquad ( 14 )$$

### Taking a recursive way to calculate Vᵢ leads to

$${V}_{i} = {V}_{i - 1} \cdot {W}_{i} ; for i = 1 , 2 , … , \frac{N - 1}{2} . \qquad ( 15 )$$

with V₀=1. The recursive forms in (13) and (15) can be derived as

$$\begin{matrix}{\prod }_{i = 1}^{\frac{N - 1}{2}} {Y}_{i}^{( \frac{N - 1}{2} - i )} = {\prod }_{i = 1}^{\frac{N - 1}{2}} {Z}_{i} , \\ and & ( 16 ) \\ {\prod }_{i = 1}^{\frac{N - 1}{2}} {W}_{i}^{( \frac{N - 1}{2} - i )} = {\prod }_{i = 1}^{\frac{N - 1}{2}} {V}_{i} . & ( 17 )\end{matrix}$$

Substituting (16) and (17) to (11) yields

$${a}_{opt} = \frac{12}{( N - 1 ) N ( N + 1 )} \cdot ln ( \vert \frac{{\prod }_{i = 1}^{\frac{N - 1}{2}} {Z}_{i}}{{\prod }_{i = 1}^{\frac{N - 1}{2}} {V}_{i}} \vert ) \qquad ( 18 )$$

### From (18), it can be seen that computing the values of Zᵢ needs

$$\frac{N - 3}{2}$$

multiplications. To compute the product of Zᵢ, it also requires

$$\frac{N - 3}{2}$$

multiplications. Hence, computing

$${\prod }_{i = 1}^{\frac{N - 1}{2}} {Z}_{i}$$

totally requires N−3 multiplications. Similarly, to compute the value of

$${\prod }_{i = 1}^{\frac{N - 1}{2}} {V}_{i}$$

needs N−3 multiplications. Using (18) to calculate aₒₚₜ needs totally 2N−6 multiplications. Thus, computing (18) leads to a linear complexity and needs only one logarithm, division and absolute operation, respectively. On the other hand, computing bₒₚₜ needs a constant complexity due to

$${Z}_{\frac{N - 1}{2}} \cdot {V}_{\frac{N - 1}{2}} \cdot X ( {k}_{c} - \frac{N + 1}{2} ) = {\prod }_{i = 1}^{N} X ( {k}_{c} - i ) \qquad ( 19 )$$

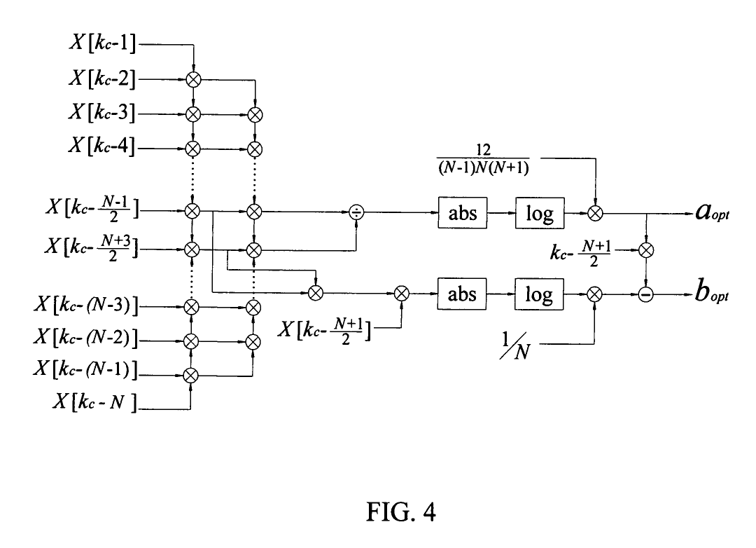

### FIG. 4 shows the flow diagram of the fast computation method.

The detail spectrum of the audio signal is reconstructed by taking and duplicating a segment of low frequency components from X[k_{c}−1] to X[k_{c}−U], where U is the reconstruction unit length. For any nonnegative integer β, X[k_{c}+β] is defined as

$$\begin{matrix}X [ {k}_{c} + β ] = \frac{X [ {k}_{c} + ( β ( mod U ) ) - U ]}{{exp}^{{b}_{opt} + {a}_{opt} ( {k}_{c} + ( β ( mod U ) ) - U )}} \cdot {exp}^{{b}_{opt} + {a}_{opt} ( {k}_{c} + β )} \\ That is , & ( 20 ) \\ X [ {k}_{c} + β ] = X [ {k}_{c} + ( β ( mod U ) ) - U ] \cdot {exp}^{{a}_{opt} ( β - ( β ( mod U ) ) + U )} & ( 21 )\end{matrix}$$

### Representing (21) as a recursive equation leads to

X[k_{c}′β]=X[k_{c}+β−U]·exp^{a}^{ₒₚₜ}^{U} ∀int β≧0 (22)

In summary, (18) and (22) constitute the frequency extension technique. There are three calibrations required for the algorithm. The first calibration is on the dithering of the zero magnitude to avoid the undefined problem of the logarithm of zero. The zero magnitudes of frequency lines are replaced with a small positive real number ε·ε needs to be adaptive with the audio frames. A too large or small ε affects the evaluation of the envelope slope. This invention calculates the average magnitude of the N frequency lines and multiplies the value by 0.001 to have ε.

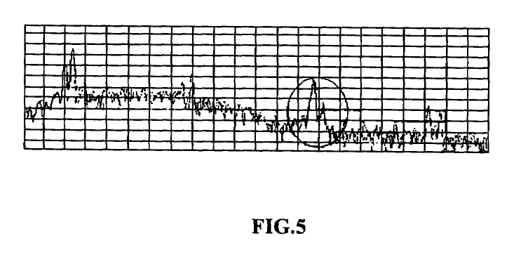

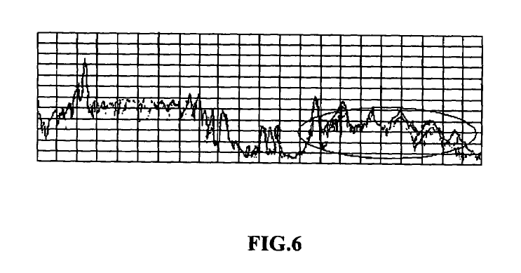

The second calibration is on the envelope parameter aₒₚₜ·aₒₚₜ should be constrained to be non-positive. Hence, the positive aₒₚₜ values are set to −0.01 to avoid the increasing in the envelope. The third calibration is on the selection of the reconstruction basis. The method extends the high frequency by duplicating the low frequency contents recursively to the high frequency contents based on a reconstruction unit. Once the content of the reconstruction unit is abnormal, the extension of high frequency components from low frequency part may not be applicable. FIG. 5 illustrates the phenomenon. In FIG. 5, there is a huge prominence that is exactly the reconstruction unit. When the reconstruction unit is used to extend for the high frequency signals, the resultant spectrum is illustrated in FIG. 6. A criterion should be used to skip the reconstruction method when there is no qualified reconstruction unit found.

A simple way for the detecting the abnormal reconstruction unit is to monitor the ratio of the summation of the frequency magnitudes on the reconstruction unit and the relative summation of estimated pseudo magnitudes.

$$\begin{matrix}Detecion Ratio ϕ = \frac{{\sum }_{i = 1}^{U} {X}_{P} [ {k}_{c} - i ]}{{\sum }_{i = 1}^{U} \vert X [ {k}_{c} - i ] \vert} \\ where & ( 23 ) \\ {\sum }_{i = 1}^{U} {X}_{P} [ {k}_{c} - i ] = {\sum }_{i = 1}^{U} {exp}^{{b}_{opt} + {a}_{opt} ( {k}_{c} - i )} , & ( 24 )\end{matrix}$$

If the ratio is lower than a threshold, the reconstruction method is skipped. Substituting (24) into (23) leads to

$$ϕ = \{ \begin{matrix}\frac{{exp}^{{b}_{opt} + {a}_{opt} {k}_{c}} \frac{( 1 - {exp}^{- {a}_{opt} U} )}{{exp}^{{a}_{opt}} - 1}}{{\sum }_{i = 1}^{U} \vert X [ {k}_{c} - i ] \vert} & if {a}_{opt} \neq 0 \\ \frac{U {exp}^{{b}_{opt}}}{{\sum }_{i = 1}^{U} \vert X [ {k}_{c} - i ] \vert} & if {a}_{opt} = 0\end{matrix} \qquad ( 25 )$$

The algorithm can be summarized as follows:
Input data: The basic sources to extend bandwidth are described below.

(a) M: X[k_{c}−N],X[k_{c}−(N−1)], . . . , X[k_{c}−1]}

(b) k_{c}: cut-off frequency

(c) k_{c}: reconstruction-ended frequency

(d) N: the size of the set M

(e) U: reconstruction unit length

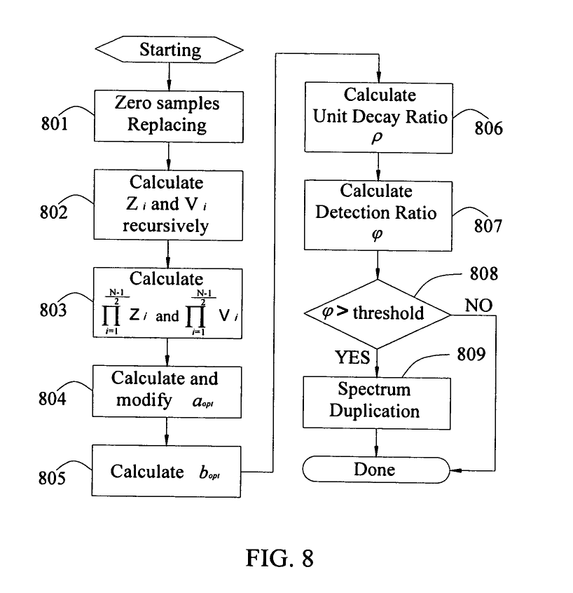

The steps of the algorithm as shown in the flow chart of FIG. 8 can be expressed as follows:
Step1 (801): Replace x[k_{c}−i] of zero value with a small real number ε, for i=1 to N.
Step2 (802): Calculate Zᵢ and vᵢ recursively, and

(a) Let zₒ=1 and v₀=1

(b) Let zᵢ=zᵢ₋₁·X[k_{c}−i] and vᵢ=vᵢ₋₁X[k_{c}−(N+1−i)] for i=1 to N.
Step3 (803): Calculate

$${\prod }_{i = 1}^{\frac{N - 1}{2}} {Z}_{i} and {\prod }_{i = 1}^{\frac{N - 1}{2}} {V}_{i}$$

respectively.
Step4 (804): Calculate aₒₚₜ according to (18).
Step5 (804): If aₒₚₜ>0, let aₒₚₜ=0.
Step6 (805): Calculate bₒₚₜ according to (3).
Step7 (806): Calculate Unit Decay Ratio ρ, ρ=exp(aₒₚₜ·U)
Step8 (807): Calculate Detection Ratio φ.
Step9 (808): If φ<threshold, the algorithm stops. Otherwise, go to Step 10.
Step10 (809): Duplicate the spectra recursively. Make X[k]=ρ·X[k−U] for k=k_{c} to k_{c}.

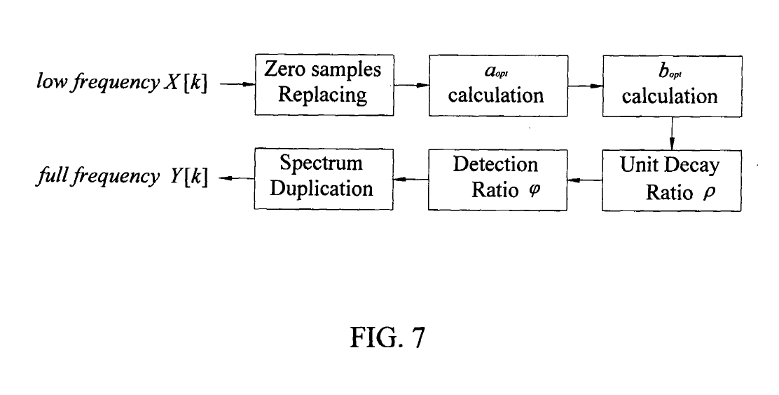

### The block diagram and the associated flow chart of the algorithm are illustrated FIG. 7 and FIG. 8 respectively.

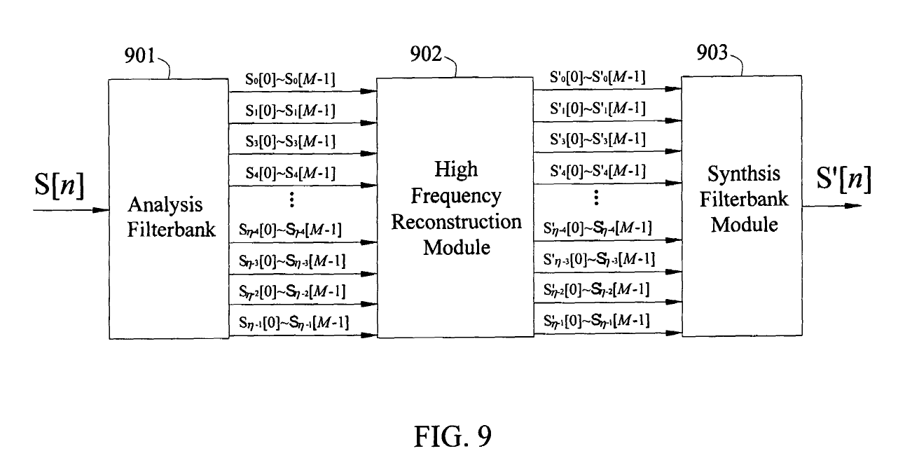

The idea of high frequency reconstruction in the frequency domain can be extended to high frequency reconstruction using filterbanks. In the second embodiment of this invention, filterbank signals are used to reconstruct the high frequency components. FIG. 9 illustrates the block diagram of the reconstruction system based on filterbank signals.

The high frequency audio signal reconstruction system of the present invention comprises an analysis filterbank 901 for splitting an audio signal over a time segment into a plurality of filterbank signals. A high frequency reconstruction module 902 reconstructs high frequency filterbank signals by means of linear extrapolation based on minimizing least squares of the logarithm scale magnitudes of the envelope elements of lower frequency filterbank signals. A synthesis filterbank module 903 combines the lower frequency filterbank signals and the reconstructed high frequency filterbank signals to synthesize the output audio signal.

A time domain audio signal S[n] of limited bandwidth is filtered by an analysis filterbank to be split into η subband signals with equal bandwidth π/η. The objective of high frequency reconstruction is to reconstruct the high frequency subband signals of zero energy to extend audio bandwidth. After high frequency reconstruction, the η subband signals, including the low frequency and reconstructed high frequency subband signals, are combined to synthesize a full bandwidth audio signal S′[n] through a synthesis filterbank.

The envelope element E[i] of a subband signal is defined as the mean square of the successive M subband signal samples over a time segment, i.e.,

$$E [ i ] = \frac{{\sum }_{j = 0}^{M - 1} \vert {S}_{j} [ j ] \vert}{M} for i = {k}_{c} - 1 to {k}_{c} - N \qquad ( 26 )$$

The η subband signals over a time segment will generate η envelope elements to comprise the envelope. Hence, for every time segment the formulas in (2) and (3) can be used to calculate the envelope slope of the subband signals by replacing X[k] with E[k]. Similarly, the other steps of transform coefficients based reconstruction method can also be modified slightly so as to be applicable to the subband signals.

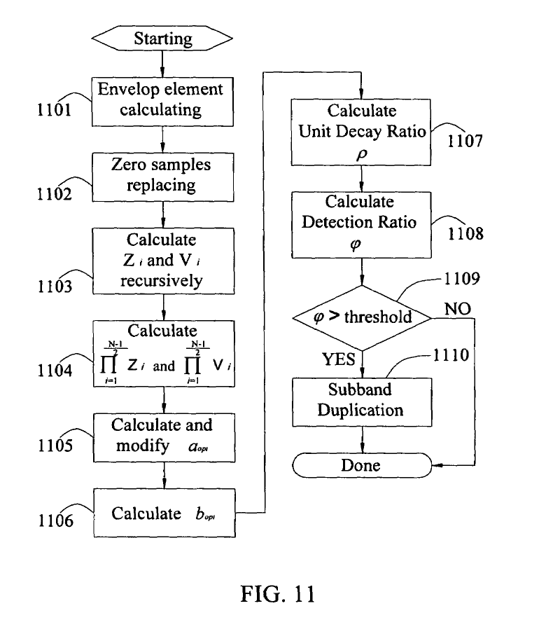

The detail algorithm as shown in FIG. 11 can be summarized as follows:
Input data: The basic sources to extend bandwidth are described below.

(a) S: N subband signals over a time segment for envelope slope calculation.

S={Sₖ_{_{c}}₋₁[n], Sₖ_{_{c}}₋₂[n], . . . , Sₖ_{_{c}}_{-N[n]|n=}0, . . . , M−1}

(b) k_{c}: cut-off frequency subband index

(c) k_{c}: reconstruction-ended frequency subband index

(d) U: reconstruction unit length

There are total nine steps of the algorithm expressed as follow:
Step1 (1101): Calculate envelope elements

$$E [ i ] = \frac{{\sum }_{j = 0}^{M - 1} \vert {S}_{j} [ j ] \vert}{M} for i = {k}_{c} - 1 to {k}_{c} - N$$

Step2 (1102): Replace E[k_{c}−i] of zero value with a small real number ε, for i=1 to N
Step3 (1103): Calculate zᵢ and vᵢ recursively, and

(a) Let z₀=1 and v₀=1

(b) Let zᵢ=zᵢ₋₁·E[k_{c}−i] and vᵢ=vᵢ₋₁·E[k_{c}−(N+1−i)] for i=1 to N.
Step4 (1104): Calculate

$${\prod }_{i = 1}^{\frac{N - 1}{2}} {Z}_{i} and {\prod }_{i = 1}^{\frac{N - 1}{2}} {V}_{i}$$

respectively.
Step5 (1105): Calculate aₒₚₜ according to (18).
Step6 (1105): If aₒₚₜ>0, let αₒₚₜ=0.
Step7 (1106): Calculate bₒₚₜ according to (3).
Step8 (1107): Calculate Unit Decay Ratio ρ, ρ=exp(aₒₚₜ·U)
Step9 (1108): Calculate Detection Ratio φ.
Step10 (1109): If φ<threshold, the algorithm stops. Otherwise, go to Step 11.
Step11 (1110): Duplicate the subbands recursively. Make sₖ[n]=ρ·Sₖ₋₁[n] for n=0 to M−1 and for i=k_{c} to k_{c}.

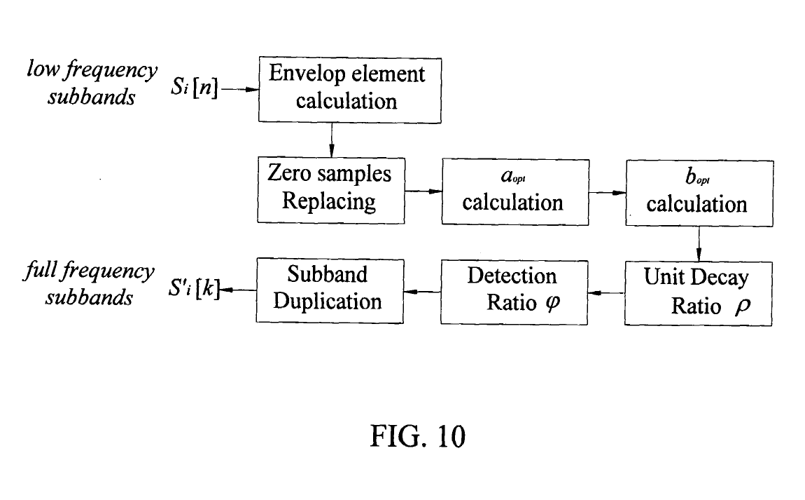

### The block diagram and the associated flow chart of the algorithm are illustrated by FIG. 10 and FIG. 11 respectively.

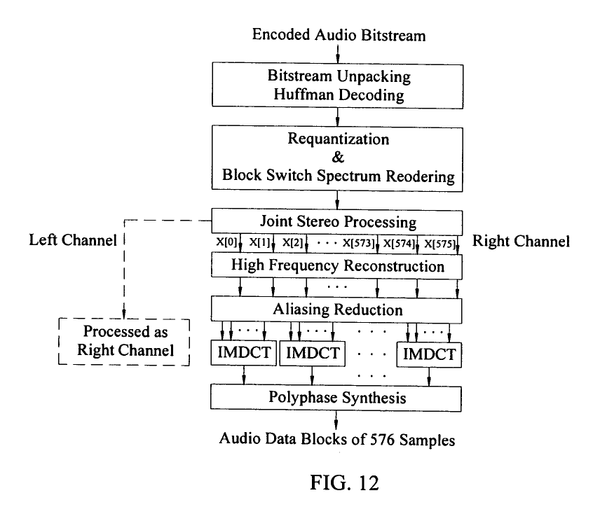

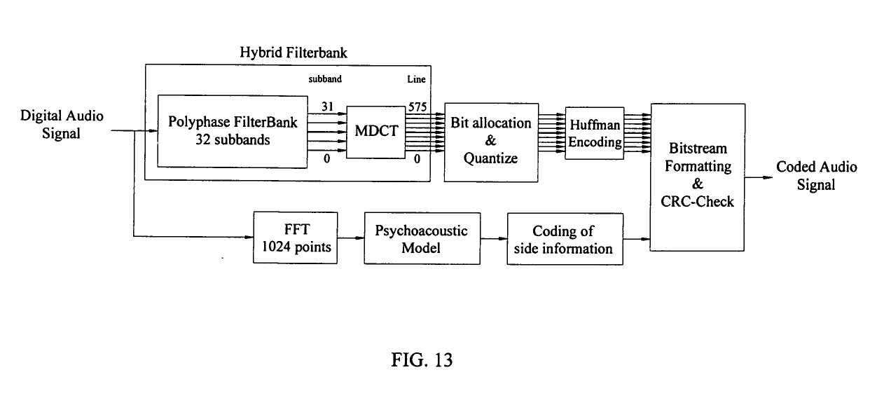

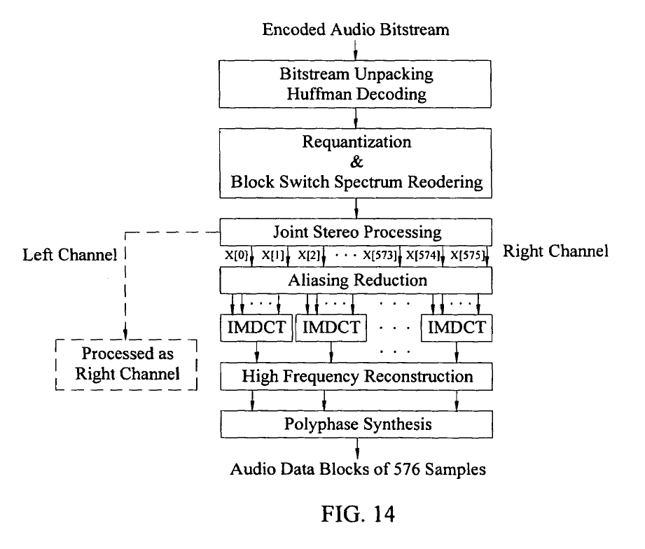

The embodiments of the present invention are readily applicable to the decoders widely used in the industry for improving the high frequency reconstruction. An MP3 encoder, due to the protocol defined, has always scarified the signal quality above 16 k. As illustrated in FIG. 12, the algorithm illustrated in the transform coefficients based reconstruction method of this invention can be directly implemented in the spectrum lines in the reconstruction of MP3 decoder to save the complexity. On the other hand, due to the hybrid filterbank framework of MPEG Layer III, as illustrated in FIG. 13, the algorithm illustrated in the filterbank signal based reconstruction method can be also implemented in the subband signals in the reconstruction of MP3 decoder. FIG. 14 illustrates the diagram of filterbank-based high frequency reconstruction method incorporated into MP3 decoder.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for reconstructing high frequency components of an audio signal, comprising generation of high frequency components by extrapolation of low frequency components of said audio signal based on scale magnitudes of transform coefficients of said low frequency components in a frequency domain.

2. The method for reconstructing high frequency components of an audio signal as claimed in claim 1, wherein said extrapolation is a approximation based on minimizing least squares of the scale magnitudes of transform coefficients of said low frequency components.

3. The method for reconstructing high frequency components of an audio signal as claimed in claim 2, wherein a linear model is used for said approximation, and a plurality of low frequency components below a cutoff frequency are used to optimize a zero order parameter and a first order parameter for said linear model.

4. The method for reconstructing high frequency components of an audio signal as claimed in claim 3, wherein a decay ratio is computed based on said first order parameter and a reconstruction unit length for predicting a transform coefficient of a predicated high frequency by multiplying said decay ratio with a frequency transform coefficient of a frequency which is lower than said predicted high frequency by said reconstruction unit length.

5. The method for reconstructing high frequency components of an audio signal as claimed in claim 4, wherein a detection ratio is computed as a ratio between the summation of the magnitudes of transform coefficients within said reconstruction unit length and the summation of estimated pseudo magnitudes of transform coefficients within said reconstruction unit length.

6. A method for reconstructing high frequency components of an audio signal, comprising generation of high frequency filterbank signals by extrapolation of low frequency filterbank signals of said audio signal based on scale magnitudes of envelope elements of said low frequency filterbank signals over a time segment.

7. The method for reconstructing high frequency components of an audio signal as claimed in claim 6, wherein said extrapolation is a approximation based on minimizing least squares of the scale magnitudes of the envelope elements of said low frequency filterbank signals.

8. The method for reconstructing high frequency components of an audio signal as claimed in claim 7, wherein a linear model is used for said approximation, and a plurality of filterbank signals below a cutoff frequency are used to optimize a zero order parameter and a first order parameter for said linear approximation.

9. The method for reconstructing high frequency components of an audio signal as claimed in claim 8, wherein a decay ratio is computed based on said first order parameter and a reconstruction unit length for predicting filterbank signals of a predicated high frequency by multiplying said decay ratio with filterbank signals of a frequency which is lower than said predicted high frequency by said reconstruction unit length.

10. The method for reconstructing high frequency components of an audio signal as claimed in claim 9, wherein a detection ratio computed as a ratio between the summation of the magnitudes of envelope elements within said reconstruction unit length and the summation of estimated pseudo magnitudes of envelope elements within said reconstruction unit length.

11. A high frequency reconstruction circuit for an audio signal, comprising a transform module for transforming said audio signal into transform coefficients in a frequency domain, a high frequency reconstruction module for reconstructing high frequency components by extrapolation of low frequency components of said audio signal based on scale magnitudes of transform coefficients of said low frequency components, and an inverse transform module for transforming transform coefficients of said low frequency components and reconstructed high frequency components.

12. A high frequency reconstruction circuit for an audio signal, comprising an analysis filterbank for splitting said audio signal over a time segment into a plurality of filterbank signals, a high frequency reconstruction module for reconstructing high frequency filterbank signals by extrapolation of low frequency filterbank signals of said audio signal based on scale magnitudes of envelope elements of said low frequency filterbank signals, and an synthesis filterbank module for combining said low frequency filterbank signals and reconstructed high frequency filterbank signals to synthesize said audio signal.
